(19) United States
(12) Patent Application Publication
(10) Pub. No.: US 2025/0284973 A1
(43) Pub. Date: Sep. 11, 2025

(54) LEARNING TO DRIVE VIA ASYMMETRIC SELF-PLAY

(71) Applicant: Waabi Innovation Inc., Toronto (CA)

(72) Inventors: Chris ZHANG, Toronto (CA); Kelvin WONG, Toronto (CA); Lunjun ZHANG, Toronto (CA); Sergio CASAS ROMERO, Toronto (CA); Raquel URTASUN, Toronto (CA)

(73) Assignee: Waabi Innovation Inc., Toronto, ON (CA)

(21) Appl. No.: 19/072,916

(22) Filed: Mar. 6, 2025

Related U.S. Application Data
(60) Provisional application No. 63/562,685, filed on Mar. 7, 2024.

(51) Int. Cl. G06N 3/096; G06N 3/092

(52) U.S. Cl. CPC G06N 3/096; G06N 3/092

(57) ABSTRACT

Learning to drive via asymmetric self-play includes executing a scenario that includes a set of actors. A student action in the scenario is determined using a student model for a student actor of the set of actors, and a teacher action in the scenario is determined using a teacher model for a teacher actor of the set of actors. Learning to drive further involves processing a student reward function based on the student action to reduce a student collision likelihood of the student model and processing a teacher reward function based on the teacher action to reduce a teacher collision likelihood of the teacher model and increase the student collision likelihood of the student model. The student model and the teacher model are iteratively updated using the student reward function and the teacher reward function. The student model is saved as a virtual driver of an autonomous system.

### CROSS REFERENCE TO RELATED APPLICATIONS

This application claims the benefit of U.S. Provisional Application No. 63/562,685, filed Mar. 7, 2024, which is incorporated by reference herein.

### BACKGROUND

In the field of autonomous systems, a challenge exists in developing control policies capable of operating in a manner that mimics human decision-making, reasons about complex interactions with other entities, and safely manages safety scenarios. Traditional methods have relied on supervised learning with large datasets collected from real-world operations. However, the supervised learning approach faces hurdles. Collecting datasets of the appropriate scale is costly, often necessitating extensive resources deployed over extended periods. Additionally, most collected data represents standard operating conditions, offering little insight into rare edge cases. Techniques like up-sampling curated scenarios address data imbalance, but are limited by the diversity of existing datasets, while inducing meaningful scenarios in the real world is impractical and hazardous at scale.

To address the challenges mentioned above, several approaches have been explored. One involves using closed-loop simulation and reinforcement learning to enable policies to explore novel states. However, simulations often feature entities exhibiting standard behavior, resulting in repetitive and unchallenging scenarios. Similarly, self-play methods in multiagent simulations may lead to cooperative behaviors that fail to reflect real-world adversarial conditions. Another strategy involves designing synthetic scenarios to target difficult interactions, but scaling the diversity of the synthetic scenarios is challenging, and the realism of the synthetic scenarios is often compromised by scripted entity behaviors, leading to a discrepancy between simulation and reality. Alternatively, automated methods like adversarial optimization can generate meaningful scenarios, but ensuring the generated scenarios are useful for training remains difficult, often resulting in scenarios that are either too trivial or too complex for effective learning.

### SUMMARY

In general, in one or more aspects, the disclosure relates to a method of learning to drive via asymmetric self-play. The method involves executing a scenario that includes a set of actors. The method further involves determining a student action in the scenario using a student model for a student actor of the set of actors. The method further involves determining a teacher action in the scenario using a teacher model for a teacher actor of the set of actors. The method further involves processing a student reward function based on the student action to reduce a student collision likelihood of the student model. The method further involves processing a teacher reward function based on the teacher action to reduce a teacher collision likelihood of the teacher model and increase the student collision likelihood of the student model. The method further involves iteratively updating the student model and the teacher model using the student reward function and the teacher reward function. The method further involves saving the student model as a virtual driver of an autonomous system.

In general, in one or more aspects, the disclosure relates to a system that includes at least one processor and an application that executes on the at least one processor. Executing the application performs executing a scenario that includes a set of actors. Executing the application further performs determining a student action in the scenario using a student model for a student actor of the set of actors. Executing the application further performs determining a teacher action in the scenario using a teacher model for a teacher actor of the set of actors. Executing the application further performs processing a student reward function based on the student action to reduce a student collision likelihood of the student model. Executing the application further performs processing a teacher reward function based on the teacher action to reduce a teacher collision likelihood of the teacher model and increase the student collision likelihood of the student model. Executing the application further performs iteratively updating the student model and the teacher model using the student reward function and the teacher reward function. Executing the application further performs saving the student model as a virtual driver of an autonomous system.

In general, in one or more aspects, the disclosure relates to a non-transitory computer readable medium including instructions executable by at least one processor. Executing the instructions performs executing a scenario that includes a set of actors. Executing the instructions further performs determining a student action in the scenario using a student model for a student actor of the set of actors. Executing the instructions further performs determining a teacher action in the scenario using a teacher model for a teacher actor of the set of actors. Executing the instructions further performs processing a student reward function based on the student action to reduce a student collision likelihood of the student model. Executing the instructions further performs processing a teacher reward function based on the teacher action to reduce a teacher collision likelihood of the teacher model and increase the student collision likelihood of the student model. Executing the instructions further performs iteratively updating the student model and the teacher model using the student reward function and the teacher reward function. Executing the instructions further performs saving the student model as a virtual driver of an autonomous system.

Other aspects of one or more embodiments may be apparent from the following description and the appended claims.

### BRIEF DESCRIPTION OF DRAWINGS

FIG. 1 shows a diagram of an autonomous training and testing system in accordance with one or more embodiments.

FIG. 2 shows a flowchart of the autonomous training and testing system in accordance with one or more embodiments.

FIG. 3 shows another diagram of an autonomous training and testing system in accordance with one or more embodiments.

FIG. 4 shows another flowchart of the autonomous training and testing system in accordance with one or more embodiments.

FIG. 5, FIG. 6, and FIG. 7 show examples in accordance with the disclosure.

FIG. 8.1 and FIG. 8.2 show computing systems in accordance with one or more embodiments of the invention.

Similar elements in the various figures may be denoted by similar names and reference numerals. The details of features and elements described in one figure may extend to similarly named features and elements in different figures.

### DETAILED DESCRIPTION

Embodiments of the present disclosure improve training methods in autonomous systems by utilizing an asymmetric self-play mechanism.

Embodiments implementing the disclosure generate challenging, solvable, and realistic scenarios through the interaction of policies with differing objectives. Specifically, embodiments of the present disclosure include a teacher policy and a student policy. The teacher policy is configured to create scenarios that the student policy cannot solve but that the teacher policy can solve, thereby producing training scenarios that push the student policy beyond nominal data. The interaction facilitates the continuous generation of different and increasingly difficult scenarios throughout the training process, establishing a progressive curriculum similar to human learning but performed autonomously. Both policies align closely with the data distribution, ensuring scenario realism and preventing policy divergence.

The asymmetric self-play mechanism yields policies that exhibit enhanced realism and robustness, particularly in complex environments such as multi-agent traffic simulations. The disclosed approach produces actor policies capable of improved performance across both standard and out-of-distribution scenarios while maintaining realistic behavior. Furthermore, the mechanism enables the zero-shot transfer of these policies to generate scenarios for new, unseen policies, enhancing adaptability. Embodiments of the disclosure support efficient training of privileged agents in lightweight simulations, which can then be deployed in high-fidelity environments to interact with end-to-end autonomy policies. The disclosed approach advances the training of autonomous systems, offering significant improvements over conventional methods such as adversarial techniques or reliance on real-world data.

An autonomous system is a self-driving mode of transportation that does not require a human pilot or human driver to move and react to the real-world environment. Rather, the autonomous system includes a virtual driver that is the decision-making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real world including moving, signaling, and stopping, or maintaining a current state.

The real-world environment is the portion of the real world through which the autonomous system, when trained, is designed to move. Thus, the real-world environment may include interactions with concrete and land, people, animals, other autonomous systems, and human driven systems, construction, and other objects as the autonomous system moves from an origin to a destination. In order to interact with the real-world environment, the autonomous system includes various types of sensors, such as LiDAR sensors amongst other types, which are used to obtain measurements of the real-world environment and cameras that capture images from the real-world environment.

The testing and training of a virtual driver of the autonomous systems in the real-world environment is unsafe because of the accidents that an untrained virtual driver can cause. Thus, as shown in FIG. 1, a simulator (100) is configured to train and test a virtual driver (102) of an autonomous system. For example, the simulator may be a unified, modular, mixed-reality, closed-loop simulator for autonomous systems. The simulator (100) is a configurable simulation framework that enables not only evaluation of different autonomy components in isolation, but also as a complete system in a closed-loop manner. The simulator reconstructs “digital twins” of real-world scenarios automatically, enabling accurate evaluation of the virtual driver at scale. The simulator (100) may also be configured to perform mixed-reality simulation that combines real-world data and simulated data to create diverse and realistic evaluation variations to provide insight into the virtual driver's performance. The mixed-reality closed-loop simulation allows the simulator (100) to analyze the virtual driver's action on counterfactual “what-if” scenarios that did not occur in the real world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) that is a virtual world in which the virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and nonstationary objects. Nonstationary objects are actors in the real-world environment.

The simulator (100) also includes an evaluator (110). The evaluator (110) is configured to train and test the virtual driver (102) by creating various scenarios in the simulated environment. Each scenario is a configuration of the simulated environment including, but not limited to, static portions, movement of simulated objects, actions of the simulated objects with each other, and reactions to actions taken by the autonomous system and simulated objects. The evaluator (110) is further configured to evaluate the performance of the virtual driver using a variety of metrics.

The evaluator (110) assesses the performance of the virtual driver throughout the performance of the scenario. Assessing the performance may include applying rules. For example, the rules may be that the automated system does not collide with any other actor, compliance with safety and comfort standards (e.g., passengers not experiencing more than a certain acceleration force within the vehicle), the automated system not deviating from an executed trajectory, or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of success criterion for a particular scenario. Further, in addition to system level performance, for modular based virtual drivers, the evaluator may also evaluate individual modules, such as segmentation or prediction performance for actors in the scene with respect to the ground truth recorded in the simulator.

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be a training phase or testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, degree of perturbations of real-world data, and whether the scenarios are designed to be adversarial. Example modes include open-loop simulation mode, closed-loop simulation mode, single module closed-loop simulation mode, fuzzy mode, and adversarial mode. In an open-loop simulation mode, the virtual driver is evaluated with real-world data. In a single module closed-loop simulation mode, a single module of the virtual driver is tested. An example of a single module closed-loop simulation mode is a localizer closed-loop simulation mode in which the simulator evaluates how the localizer estimated pose drifts over time as the scenario progresses in simulation. In a training data simulation mode, simulator is used to generate training data. In a closed-loop evaluation mode, the virtual driver and simulation system are executed together to evaluate system performance. In the adversarial mode, the actors are modified to perform adversarially. In the fuzzy mode, noise is injected into the scenario (e.g., to replicate signal processing noise and other types of noise). Other modes may exist without departing from the scope of the system.

The simulator (100) includes the controller (112) that includes functionality to configure the various components of the simulator (100) according to the selected mode and phase. Namely, the controller (112) may modify the configuration of each of the components of the simulator based on the configuration parameters of the simulator (100). Such components include the evaluator (110), the simulated environment (104), an autonomous system model (116), sensor simulation models (114), asset models (117), actor models (118), latency models (120), and a training data generator (122).

The autonomous system model (116) is a detailed model of the autonomous system in which the virtual driver will execute. The autonomous system model (116) includes model, geometry, physical parameters (e.g., mass distribution, points of significance), engine parameters, sensor locations and type, firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, the measurements being simulated, based on the simulated environment, based on the simulated position of the sensor(s), within the simulated environment. By way of an example, the active sensor measurements may be measurements that a LiDAR sensor would make of the simulated environment over time and in relation to the movement of the autonomous system.

The sensor simulation models (114) are configured to simulate the sensor observations of the surrounding scene in the simulated environment (104) at each time step according to the sensor configuration on the vehicle platform. When the simulated environment directly represents the real-world environment, without modification, the sensor output may be directly fed into the virtual driver. For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in the real world and use the same autonomous system as in the real world, the original sensor observations may be replayed at each time step.

Asset models (117) include multiple models, each model modeling a particular type of individual asset in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the entities or assets in the scenario. The assets can be composed together to form the three dimensional simulated environment. An asset model provides all the information needed by the simulator to simulate the asset. The asset model provides the information used by the simulator to represent and simulate the asset in the simulated environment. For example, an asset model may include geometry and bounding volume, the asset's interaction with light at various wavelengths of interest (e.g., visible for camera, infrared for LiDAR, microwave for RADAR), animation information describing deformation (e.g., rigging) or lighting changes (e.g., turn signals), material information such as friction for different surfaces, and metadata such as the asset's semantic class and key points of interest. Certain components of the asset may have different instantiations. For example, similar to rendering engines, an asset geometry may be defined in many ways, such as a mesh, voxels, point clouds, an analytical signed-distance function, or neural network. Asset models may be created either by artists, or reconstructed from real-world sensor data, or optimized by an algorithm to be adversarial.

Closely related to, and possibly considered part of the set of asset models (117) are actor models (118). An actor model represents an actor in a scenario and may be an implementation of the autonomous system model (116). An actor is a sentient being that has an independent decision-making process. Namely, in the real world, the actor may be an animate being (e.g., person or animal) that makes a decision based on an environment. The actor makes active movement rather than or in addition to passive movement. An actor model, or an instance of an actor model may exist for each actor in a scenario. The actor model is a model of the actor. If the actor is in a mode of transportation, then the actor model includes the model of transportation in which the actor is located. For example, actor models may represent pedestrians, children, vehicles being driven by drivers, pets, bicycles, and other types of actors.

The actor model leverages the scenario specification and assets to control all actors in the scene and their actions at each time step. The actor's behavior is modeled in a region of interest centered around the autonomous system. Depending on the scenario specification, the actor simulation will control the actors in the simulation to achieve the desired behavior. Actors can be controlled in various ways. One option is to leverage heuristic actor models, such as intelligent-driver models (IDMs) that try to maintain a certain relative distance or time-to-collision (TTC) from a lead actor or heuristic-derived lane-change actor models. Another is to directly replay actor trajectories from a real log, or to control the actor(s) with a data-driven traffic model. Through the configurable design, embodiments may mix and match different subsets of actors to be controlled by different behavior models. For example, far-away actors that initially may not interact with the autonomous system and can follow a real log trajectory, but when near the vicinity of the autonomous system may switch to a data-driven actor model. In another example, actors may be controlled by a heuristic or data-driven actor model that still conforms to the high-level route in a real log. This mixed-reality simulation provides control and realism.

Further, actor models may be configured to be in a cooperative or adversarial mode. In cooperative mode, the actor model models actors to act rationally in response to the state of the simulated environment. In adversarial mode, the actor model may model actors acting irrationally, such as exhibiting road rage and bad driving.

The latency model (120) represents timing latency that occurs when the autonomous system is in the real-world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. The latency model simulates the exact timings and latency of different components of the onboard system. To enable scalable evaluation without strict requirement on exact hardware, the latencies and timings of the different components of autonomous system and sensor modules are modeled while running on different computer hardware. The latency model may replay latencies recorded from previously collected real-world data or have a data-driven neural network that infers latencies at each time step to match the hardware in loop simulation setup.

The training data generator (122) is configured to generate training data. For example, the training data generator (122) may modify real-world scenarios to create new scenarios. The modification of real-world scenarios is referred to as mixed-reality. For example, mixed-reality simulation may involve adding in new actors with novel behaviors, changing the behavior of one or more of the actors from the real world, and modifying the sensor data in that region while keeping the remainder of the sensor data the same as the original log. In some cases, the training data generator (122) converts a benign scenario into a safety-critical scenario.

The simulator (100) is connected to a data repository (105). The data repository (105) is any type of storage unit or device that is configured to store data. The data repository (105) includes data gathered from the real world. For example, the data gathered from the real world include real actor trajectories (126), real sensor data (128), real trajectory of the system capturing the real world (130), and real latencies (132). Each of the real actor trajectories (126), real sensor data (128), real trajectory of the system capturing the real world (130), and real latencies (132) is data captured by or calculated directly from one or more sensors from the real world (e.g., in a real-world log). In other words, the data gathered from the real world are actual events that happened in real life. For example, in the case that the autonomous system is a vehicle, the real-world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of the autonomous system (e.g., the full 6D pose, velocity and acceleration), the map information specifying the road layout, and the scene layout specifying the initial state of all the dynamic actors and objects in the scenario. The scenario specification may also include dynamic actor information describing how the dynamic actors in the scenario should evolve over time, which are inputs to the actor models. The dynamic actor information may include route information for the actors, desired behaviors, or aggressiveness. The scenario specification (140) may be specified by a user, programmatically generated using a domain-specification language (DSL), procedurally generated with heuristics from a data-driven algorithm, or adversarial. The scenario specification (140) can also be conditioned on data collected from a real-world log, such as taking place on a specific real-world map or having a subset of actors defined by their original locations and trajectories.

The interfaces between virtual driver and the simulator match the interfaces between the virtual driver and the autonomous system in the real world. For example, the sensor simulation model (114) and the virtual driver matches the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real-world setting.

FIG. 2 shows a flow diagram of the process (200) for executing the simulator in a closed-loop mode. In Block 201, a digital twin of a real-world scenario is generated as a simulated environment state. Log data from the real world is used to generate an initial virtual world. The log data defines which asset and actor models are used in an initial positioning of assets. For example, using convolutional neural networks on the log data, the various asset types within the real world may be identified. As other examples, offline perception systems and human annotations of log data may be used to identify asset types. Accordingly, corresponding asset and actor modes may be identified based on the asset types and added to the positions of the real actors and assets in the real world. Thus, the asset and actor models to create an initial three dimensional virtual world.

In Block 203, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver.

The simulated sensor output is passed to the virtual driver. In Block 205, the virtual driver executes based on the simulated sensor output to generate actuation actions. The actuation actions define how the virtual driver controls the autonomous system. For example, for an SDV, the actuation actions may be the amount of acceleration, movement of the steering, triggering of a turn signal, etc. From the actuation actions, the autonomous system state in the simulated environment is updated in Block 207. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snow environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 209, actors' actions in the simulated environment are modeled based on the simulated environment state. Concurrently with the virtual driver model, the actor models and asset models are executed on the simulated environment state to determine an update for each of the assets and actors in the simulated environment. Here, the actors' actions may use the previous output of the evaluator to test the virtual driver. For example, if the actor is adversarial, the evaluator may indicate based on the previous action of the virtual driver, the lowest scoring metric of the virtual driver. Using a mapping of metrics on the actions of the actor model, the actor model executes to exploit or test that particular metric.

Thus, in Block 211, the updated simulated environment state is updated according to the actors' actions and the autonomous system state. The updated simulated environment includes the changes in position of the actors and the autonomous system. Because the models execute independently of the real world, the update may reflect a deviation from the real world. Thus, the autonomous system is tested with new scenarios. In Block 213, a determination is made whether to continue. If the determination is made to continue, testing of the autonomous system continues using the updated simulated environment state in Block 203. At each iteration, during training, the evaluator provides feedback to the virtual driver. Thus, the parameters of the virtual driver are updated to improve performance of the virtual driver in a variety of scenarios. During testing, the evaluator is able to test using a variety of scenarios and patterns including edge cases that may be safety critical. Thus, one or more embodiments improve the virtual driver and increase safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

Turning to FIG. 3, the system (300) learns to operate autonomous systems via asymmetric self-play. The student model (330) learns from the teacher model (350) and is then deployed to the autonomous system (380). The system (300) includes the training application (302) and the autonomous system (380), which may each include multiple hardware and software components that may be a part of and execute on the computing components described in the other figures, including those of FIG. 1. For example, the simulator (320), the virtual driver (382), and the autonomous system (380) may respectively be implementations of the simulator (100), the virtual driver (102), and an autonomous system onto which the virtual driver (102) of FIG. 1 is deployed. As another example, the autonomous system model A (332) and the autonomous system model B (352) may each be implementations of the autonomous system model (116) of FIG. 1. The teacher model (350) and the student model (330) may be implementations of the actor models (118) of FIG. 1. The actors (308) may be implementations of the actors represented by the actor models (118) of FIG. 1.

The training application (302) is a software application that trains the student model (330) and the teacher model (350). The training application (302) operates the simulator (320) with the student model (330), the student reward function (340), the teacher model (350), and the teacher reward function (360) using the scenario (305) to generate the state data (325), the student action (338), and the teacher action (358) as a part of the training process. The training application (302) may use multiple scenarios, including the scenario (305), to train the student model (330) and the teacher model (350).

The scenario (305) is one of the scenarios used to train the student model (330) and the teacher model (350). The scenario (305) is an input to the simulator (320). The scenario (305) includes the actors (308).

The actors (308) represent objects within a simulation operated by the simulator (320). Objects represented by the actors may include vehicles, pedestrians, trees, etc. The actors (310), include the student actor (310) and the teacher actor (312).

The student actor (310) is one of the actors (308). The student actor (310) is an actor in the scenario (305) that is controlled by the student model (330). The student actor (310) may be one of multiple student actors operated by the student model (330) in the scenario (305).

The teacher actor (312) is one of the actors (308). The teacher actor (312) is an actor in the scenario (305) that is controlled by the teacher model (350). The teacher actor (312) may be one of multiple teacher actors operated by the teacher model (350) in the scenario (305).

The simulator (320) is an application that creates a simulated environment to test and train the student model (330) and the teacher model (350). The simulator (320) processes the scenario (305) along with the student action (338) and the teacher action (358) to generate the state data (325).

The state data (325) is the output from the simulator (320). The state data (325) includes the state of each of the actors (308) in the simulated environment created by the simulator (320). The state data (325) is input to the student model (330) and to the teacher model (350) and may be input to the student reward function (340) and the teacher reward function (360).

The student model (330) is a machine learning model. The student model (330) processes the state data (325) to generate the student action (338) using the autonomous system model A (332) and the student policy (335).

The autonomous system model A (332) is a machine learning model that may be used to control the autonomous system (380). The autonomous system model A (332) may be a neural network model that includes multiple layers, blocks, encoders, decoders, etc., to process data. The autonomous system model A (332) may include a map encoder, a state encoder, multiple transformer blocks, an action decoder, etc. The map encoder encodes geographical map information such as a lane graph. The state encoder encodes the states of the actors (308) in the scenario (305). The multiple transformer blocks process the outputs from the encoders to generate input to the decoder. The action decoder decodes the output of the multiple blocks into actions that may be performed by the actors (308).

The student policy (335) are the weights and parameters for the autonomous system model A (332). The student policy (335) is trained to avoid collisions with the autonomous systems that may be controlled by the student model (330), i.e., to reduce the student collision likelihood (342).

The student action (338) is the action identified by the student model (330) to take in response to the state data (325). The student action (338) may include adjustments for steering, braking, acceleration, etc., of the autonomous system (380).

The student reward function (340) is a function that determines the reward, if any, earned by the student model (330) responsive to the student action (338). The reward may be proportionate to the lack of a collision by the student actor (310) with one or more of the other actors (308) of the scenario (305) in the simulated environment generated by the simulator (320). Output from the student reward function (340) may be used to update the weights and parameters of the student model (330). The student reward function (340) may incorporate the student collision likelihood (342) to reduce collisions by the student model (330).

The student collision likelihood (342) is the likelihood that the student actor (310) collided with one of the other actors (308) in a simulated environment. As an example, the student collision likelihood (342) may have a value of zero for no collision detected in the simulated environment and a value of one for a collision detected in the simulated environment.

The teacher model (350) is a machine learning model that differs from the student model (330) at least by the teacher policy (355). The teacher model (350) processes the state data (325) to generate the teacher action (358) using the autonomous system model B (352) and the teacher policy (355).

The autonomous system model B (352) is a machine learning model that may be the same or similar to the autonomous system model A (332) including the same or similar layers, blocks, encoders, decoders, etc., as the autonomous system model A (332). The autonomous system model B (352) may differ from the autonomous system model A (332) by encoding additional information that identifies the types of actors in the scenario (305) as being students (e.g., the student actor (310)) or teachers (e.g., the teacher actor (312)).

The teacher policy (355) are the weights and parameters for the autonomous system model B (352). The teacher policy (355) is trained to avoid collisions with the autonomous systems that may be controlled by the teacher model (350), i.e., to reduce the teacher collision likelihood (362), but also to cause collisions by the student model (330), i.e., to increase the student collision likelihood (342).

The teacher reward function (360) is a function that determines the reward, if any, earned by the teacher model (350) responsive to the teacher action (358). The reward may be proportionate to the lack of a collision by the teacher actor (312) with one or more of the other actors (308) of the scenario (305) in the simulated environment generated by the simulator (320). The reward may also be proportionate to the presence of a collision by the student actor (310) with one or more of the other actors (308) of the scenario (305) in the simulated environment generated by the simulator (320). Output from the teacher reward function (360) may be used to update the weights and parameters of the teacher model (350). The teacher reward function (360) may incorporate the teacher collision likelihood (362) to reduce collisions by the teacher model (350) and include the student collision likelihood (342) to increase collisions by the student model (330).

The teacher collision likelihood (362) is the likelihood that the teacher actor (312) collided with one of the other actors (308) in a simulated environment. As an example, the teacher collision likelihood (362) may have a value of zero for no collision detected in the simulated environment and a value of one for a collision detected in the simulated environment. The autonomous system (380) is a system that may be controlled with the student model (330). The autonomous system (380) includes the virtual driver (382).

The virtual driver (382) is the program that controls the autonomous system (380). The virtual driver (382) may include the student model (330) to make the decisions to control the autonomous system (380).

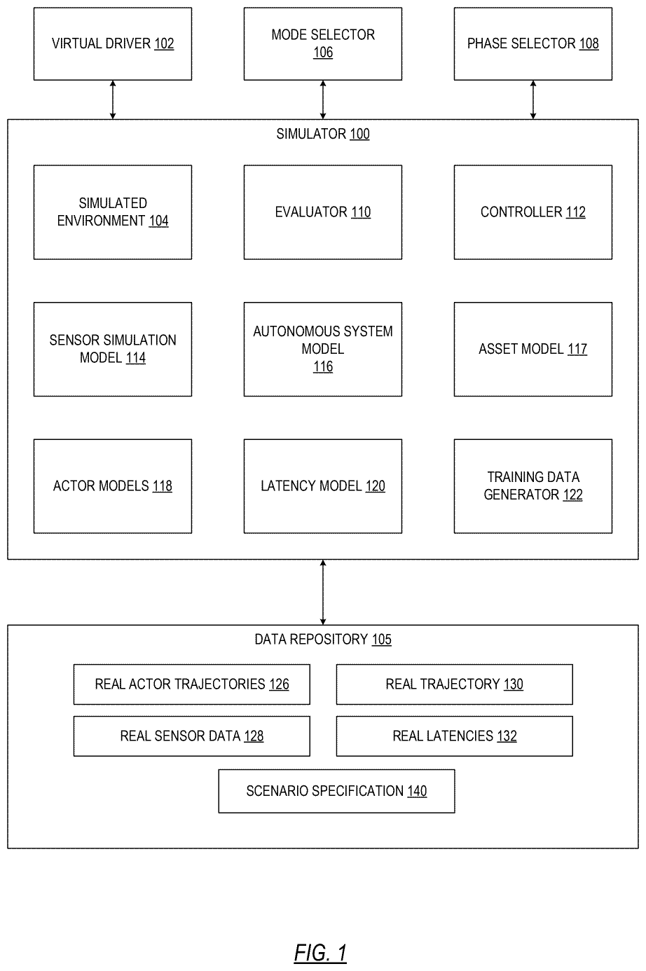

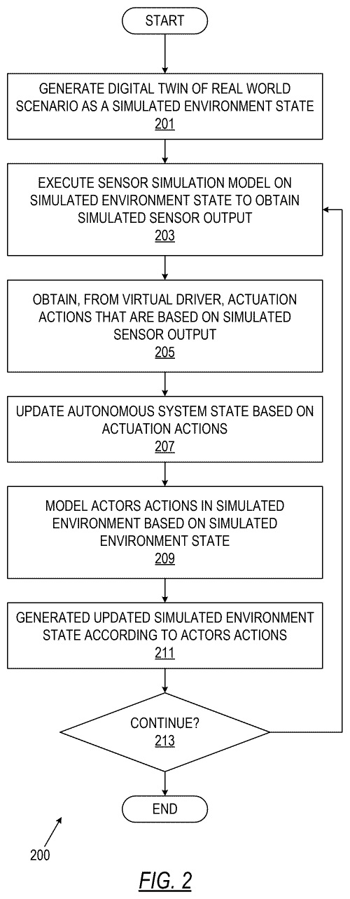

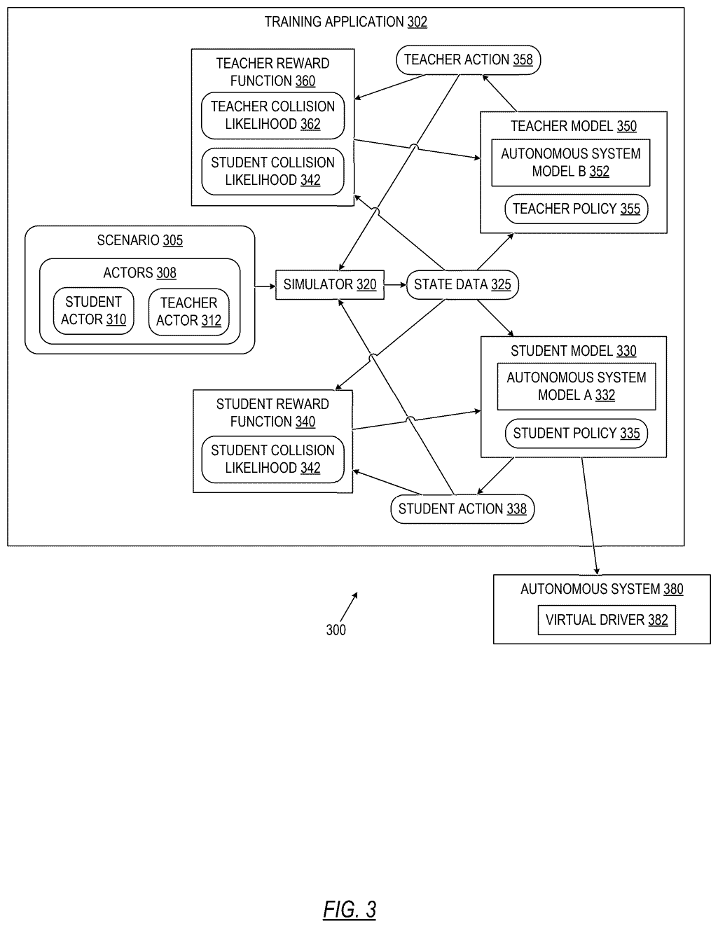

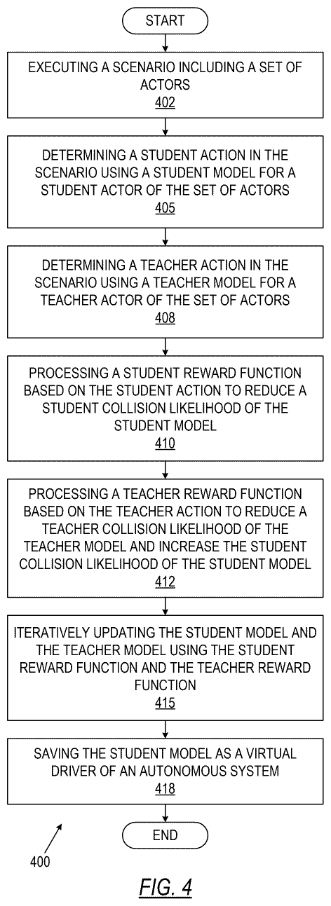

FIG. 4 shows a flowchart of a method that implements learning to drive via asymmetric self-play. The method of FIG. 4 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

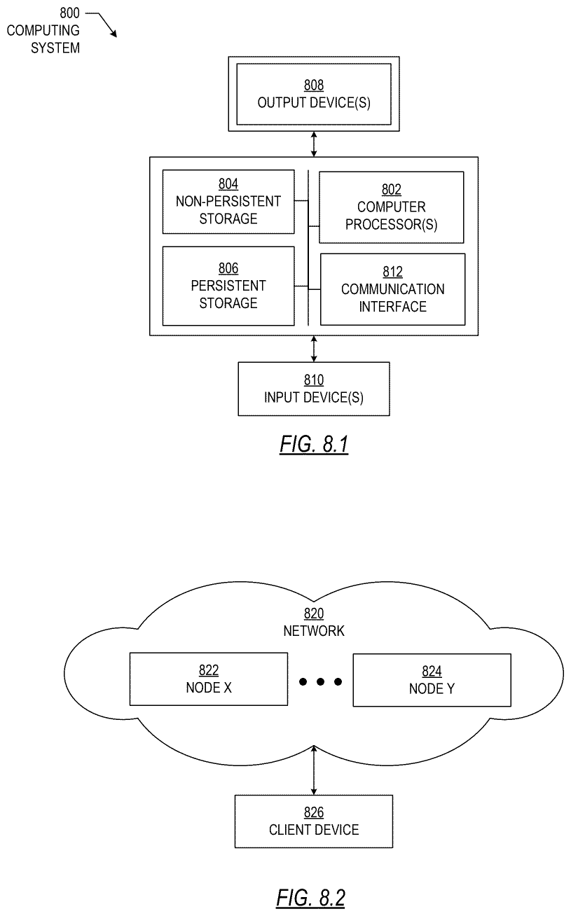

Turning to FIG. 4, the process (400) may be used to refine a student model with a teacher model and asymmetric student and teacher reward functions. The process (400) may include multiple steps (e.g., steps (402) through (412)) that may execute on the components described in the other figures, including those of FIG. 1, FIG. 8, FIGS. 12.1, and 12.2.

Block 402 includes executing a scenario that includes a set of actors. In the execution of the scenario, a simulated environment is initiated, where computational models are employed to represent and control the behavior of the actors within the scenario. The actors, which may include vehicles, pedestrians, or other dynamic elements, interact according to predefined rules or algorithms designed to mimic real-world conditions. Execution of the scenario execution is managed by an engine of the simulator that processes inputs from the actors and the autonomous system model, generating outputs that reflect the evolving state of the environment. The controlled simulation framework may systematically test, train, and evaluate the autonomous system model under a variety of conditions to assess the autonomous system model without the risks associated with real-world deployment.

Executing the scenario may include operating an autonomous system model using a student policy as the student model. Operating the autonomous system model as the student model includes loading the weights and parameters of the student policy into the autonomous system model to use for the decision-making of the autonomous system model.

Executing the scenario may include executing the autonomous system model using a teacher policy as the teacher model. Operating the autonomous system model as the teacher model includes loading the weights and parameters of the teacher policy into the autonomous system model to use for the decision-making of the autonomous system model.

Block 405 includes determining a student action in the scenario using a student model for a student actor of the set of actors. The student model processes the current state of the scenario, which includes the positions, movements, and interactions of the actors, to determine an appropriate action for a student actor. The student model selects an action, such as changing direction or adjusting speed, that aligns with the objective of avoiding collisions within the simulated environment. The determination is performed by a series of computational steps that transform the data of the scenario into actionable decisions for the student actor using the different blocks and layers of the autonomous system model. The blocks and layers of the autonomous system model may include a map encoder, a state encoder, a set of transformer blocks, an action decoder, etc., which may be used by both the student model (to determine student actions) and by the teacher model (to determine teacher actions).

Determining the student action (as well as a teacher action) may include processing a lane graph with a map encoder to generate lane graph node features. The map encoder takes the lane graph, which represents the road layout and traffic constraints, and processes the lane graph to extract features, in the form of feature vectors, from each node in the graph. The nodes may correspond to points in the road network, such as intersections or lane segments. By applying a series of transformations, the map encoder converts the structural information of the lane graph into a set of feature vectors that capture spatial relationships, connectivity, and other map-related attributes for decision-making in the scenario. The features for the lane graph may be referred to as a lane graph node feature.

Determining the student action (as well as a teacher action) may include processing actor data with a state encoder to generate actor features for one or more of the teacher model and the student model. The state encoder receives data about each actor in the scenario, including the current positions, velocities, and other dynamic attributes. Through a sequence of encoding operations, the state encoder transforms data into a feature representation that summarizes the characteristics of the state of each actor. The features for the actors may be referred to as actor features.

Determining the student action (as well as a teacher action) may include processing lane graph node features and actor features using a set of transformer blocks to generate transformer block output features for one or more of the student model (as well as the teacher model). Each of the transformer blocks comprises a map cross attention block, an actor self attention block, and a time self attention block. The transformer blocks integrate the lane graph node features and actor features by applying attention mechanisms that capture relationships across different dimensions. The map cross attention block correlates actor features with map features, allowing the model to understand how actors are positioned relative to the road layout. The actor self attention block enables actors to attend to one another, facilitating the modeling of interactions and potential conflicts. The time self attention block processes temporal information, helping the model account for the sequence of events and predict future states. Through the attention mechanisms, the transformer blocks produce output features that encapsulate an understanding of the spatial, social, and temporal dynamics of the scenario.

Determining the student action (as well as a teacher action) may include processing transformer block output features with an action decoder to generate a set of actor actions for one or more of the teacher model and the student model. The action decoder receives the output features from the transformer blocks, which are decoded into specific actions for each actor. By interpreting the contextual information embedded in the transformer output, the action decoder identifies actions, calculated from movements, for accelerating, braking, changing lanes, etc., that the actors may execute in the scenario. The decoding process translates the high-level feature representations into actionable commands for the actors to navigate the simulated environment while avoiding collisions.

Block 408 includes determining a teacher action in the scenario using a teacher model for a teacher actor of the set of actors. The teacher model processes the current state of the scenario, which includes the positions, movements, and interactions of the actors, to select an appropriate action for a teacher actor. The teacher model selects an action, such as adjusting speed, altering direction, or engaging with other actors, that aligns with the objective of avoiding collisions by the teacher actors and increasing the chance of collisions by the student actors.

Determining the teacher action may include determining the teacher action in the scenario from one of an adversary sub-policy and a demonstrator sub-policy. The teacher policy may be split into an adversary sub-policy and a demonstrator sub-policy. The adversary policy is adverse to the student policy taking actions to create scenarios and states that cause the student policy to fail, e.g., to be involved in a collision. The demonstrator policy acts as a demonstration by taking actions to navigate a scenario without a collision where the student policy may have a collision. The adversary sub-policy generates actions that create challenging situations for the student actor, testing the ability of the student model to respond. The demonstrator sub-policy produces actions that demonstrate optimal behavior, guiding the student actor toward improved performance.

Determining the teacher action may include revising actor features with a targeting embedding to distinguish between the student actor controlled by the student model and the teacher actor controlled by the teacher model. The values in the targeting embedding distinguish between actors controlled by the student model and actors controlled by the teacher model. The targeting embedding may be added to the actor features output from the state encoder. The targeting embedding may be used by the teacher model and not by the student model.

Block 410 includes processing a student reward function based on the student action to reduce a student collision likelihood of the student model. The student reward function is evaluated by analyzing the student action within the context of the current state of the scenario, which includes the positions and movements of the actors. The evaluation calculates a reward value that reflects the desirability of the action, with higher rewards assigned to actions that minimize the likelihood of collision for the student actor. The reward function may incorporate penalties for actions that increase collision risk, such as moving too close to other actors or failing to yield, thereby guiding the student model toward safer decision-making. The process may be performed iteratively during training, allowing the student model to be refined over time by learning from the feedback provided by the reward function.

Processing the student reward function may include processing the student reward function with a regularization hyperparameter controlling a combined regularization term. The combined regularization term regularizes the rewards for each policy, student, and teacher, used in the scenario. The regularization hyperparameter is integrated into the reward function to adjust the weight of the combined regularization term, which influences the overall reward calculation. The combined regularization term aggregates penalties or bonuses based on specific criteria, such as deviation from a desired behavior or adherence to safety constraints. By tuning the regularization hyperparameter, the impact of the regularization term on the reward function is controlled, to balance between encouraging optimal actions and enforcing additional constraints. The adjustment from the regularization hyperparameter and the combined regularization term is applied during the computation of the reward function so that the training of the student model is shaped by both the primary objective (avoiding collisions) and the regularization.

Block 412 includes processing a teacher reward function based on the teacher action to reduce a teacher collision likelihood of the teacher model and increase the student collision likelihood of the student model. The teacher reward function is evaluated by analyzing the teacher action within the context of the current state of the scenario, which encompasses the positions, movements, and interactions of the actors. The evaluation calculates a reward value reflecting the desirability of the action, assigning higher rewards to actions that minimize the likelihood of collision for the teacher actor while simultaneously increasing the collision risk for the student actor. Penalties are incorporated into the reward function for actions elevating the collision risk of the teacher model, such as moving too close to other actors or failing to maintain safe distances, while bonuses are added for actions creating challenging situations for the student model, such as positioning the teacher actor to test the decision-making of the student actor. The reward is determined by simulating potential outcomes of the teacher action and assigning values based on the predicted effects on both the teacher and student models. The processing occurs iteratively during training, to refine the behavior of the teacher model over time by learning from the feedback provided by the teacher reward function.

Processing the teacher reward function may include processing the teacher reward function with a regularization hyperparameter controlling a teacher regularization term and a combined regularization term. Where the combined regularization term regularizes the rewards for each policy, student and teacher, used in the scenario, the teacher regularization term regularizes the rewards for the teacher policy used in the scenario. The regularization hyperparameter used in the teacher reward function may be the same or similar to the hyperparameter used in the student reward function. The regularization hyperparameter is integrated into the reward function to adjust the weight of the teacher regularization term and the combined regularization term, which influence the overall reward calculation. Penalties or bonuses are applied through the teacher regularization term based on criteria specific to the teacher model, such as deviation from expert behavior or adherence to safety protocols, while constraints relevant to both the teacher and student models, such as maintaining realistic interactions or ensuring scenario diversity, are enforced via the combined regularization term. The impact of the regularization terms on the reward function is controlled by tuning the regularization hyperparameter, balancing encouragement of actions that achieve the primary objective of reducing the teacher collision likelihood and increasing the student collision likelihood with enforcement of additional constraints shaping the training process. The adjustment from the regularization hyperparameter, the teacher regularization term, and the combined regularization term is applied during the computation of the reward function, guiding the training of the teacher model.

Block 415 includes iteratively updating the student model and the teacher model using the student reward function and the teacher reward function. The student reward function and the teacher reward function generate reward values based on the actions taken by the student model and the teacher model in the scenario. The reward values are fed into an optimization algorithm that adjusts the weights and parameters of the student model and the teacher model to improve performance. The optimization algorithm may compute gradients from the reward values, applying those gradients to update the decision-making rules embodied in the weights and parameters of each model incrementally. The adjustment process repeats over multiple iterations, with each iteration refining the models by incorporating feedback from the reward functions until a desired level of performance is achieved.

Block 418 includes saving the student model as a virtual driver of an autonomous system. The student model, after completing updates, may be converted into a format compatible with the operational software of the autonomous system. The conversion may include serializing the weights and parameters for decision-making rules of the student model into a data file or executable module. The data file or module is stored in a memory location accessible to the autonomous system, such as an onboard computer or a networked storage device.

The process (400) may include deploying the student model to the autonomous system. The saved student model is transferred from a storage location to the operational environment of the autonomous system, such as an onboard processor or a control unit. Transferring the student model includes loading the weights and parameters of the model into the active memory of the autonomous system. Once loaded, the student model integrates with the hardware and software interfaces of the autonomous system, enabling the student model to receive sensor inputs and issue commands. The integration of the student model to the autonomous system utilizes the student model to navigate and effectively respond to the surroundings of the autonomous system.

The process (400) may include executing the student model to operate the autonomous system to avoid a collision. The student model, once deployed, receives real-time data from the sensors of the autonomous system, such as cameras or radar, capturing the positions and movements of objects in the environment. Using the received data, the student model processes the information through the weights and parameters that form decision-making rules to determine the actions, such as steering, acceleration, braking, etc., that prevent the autonomous system from colliding with obstacles or other actors. The actions are transmitted as commands to the actuators of the autonomous system, which execute the movements accordingly. The operation occurs continuously, so that the autonomous system may adjust in response to changing conditions and maintain safe navigation.

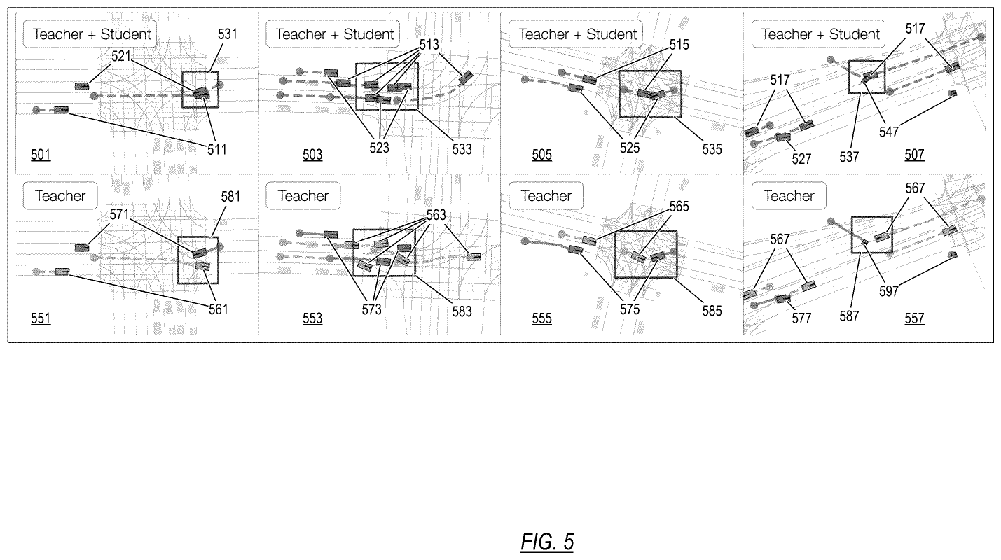

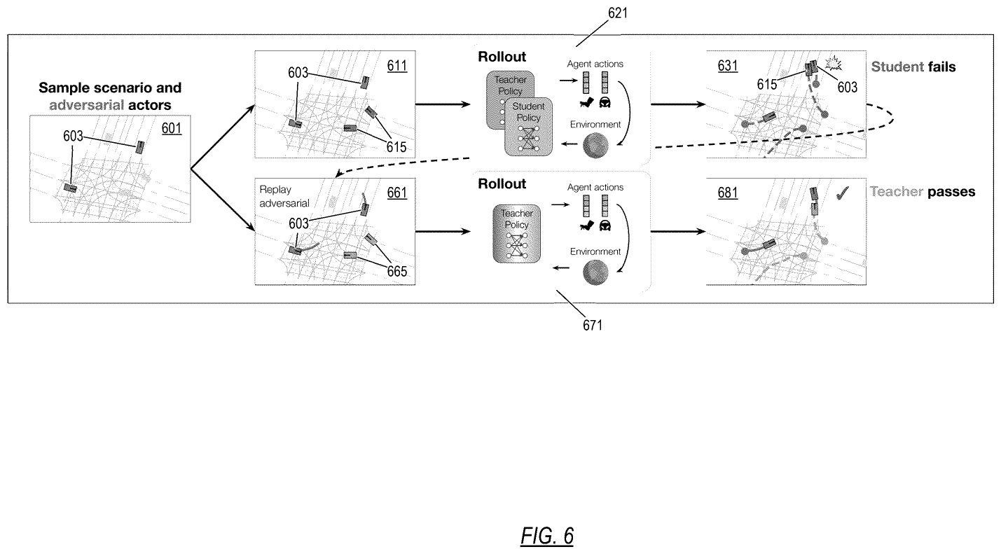

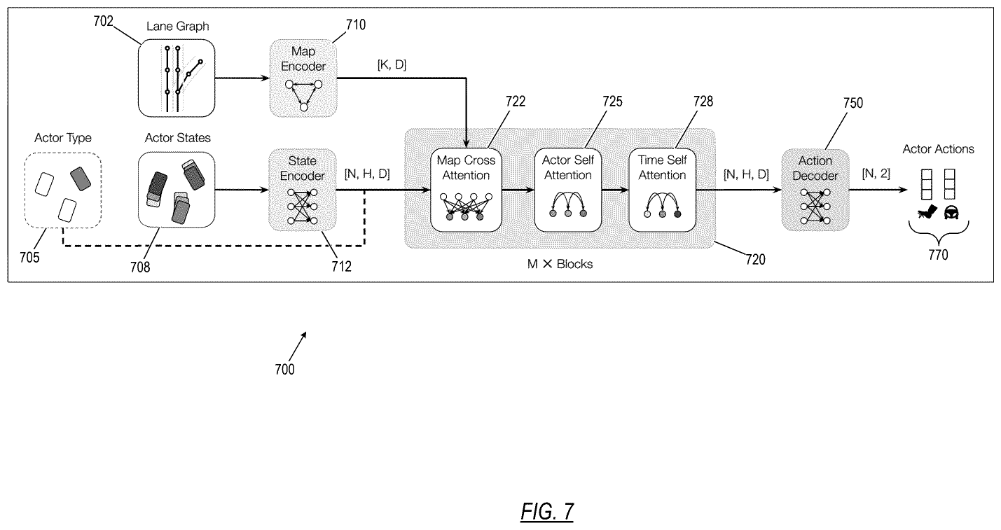

Turning to FIG. 5, examples of asymmetric self-play are shown with multiple scenarios using multiple combinations of teacher and student models, which may be displayed on a user interface, collectively or individually, as the images (501), (503), (505), (507), (551), (553), (555), and (557). The images (501) and (551) correspond to a first scenario, the images (503) and (553) correspond to a second scenario, the images (505) and (555) correspond to a third scenario, and the images (507) and (557) correspond to a fourth scenario. The images (501), (503), (505), and (507) correspond to examples where the teacher model and the student model are used to control different actors in the scenario. The images (551), (553), (555), and (557) correspond to examples where the teacher model is used without the student model to control the different actors in the scenario.

The actors controlled by the student model with a student policy include the student actors (511), (513), (515), and (517) (which may be shaded blue). The actors controlled by the teacher model with an adversarial teacher policy include the adversarial actors (521), (523), (525), (527), (547), (571), (573), (575), (577), and (597) (which may be shaded red). The adversarial actors (547) and (597) represent pedestrians and the other adversarial actors (521), (523), (525), (527), (571), (573), (575), and (577) represent vehicles. The actors controlled by the teacher model with a demonstrator teacher policy include the demonstrator actors (561), (563), (565), and (567) (which may be shaded green). The location of a collision by the student model is shown with the boxes (531), (533), (535), and (537). The location of the teacher model avoiding the collision is shown with the boxes (581), (583), (585), and (587).

The teacher controlled actors learn to generate realistic scenarios where the student-controlled actors may make a mistake (depicted in the images (501), (503), (505), and (507)), while making sure the teacher can demonstrate the proper behavior itself (depicted in the images (551), (553), (555), and (557)). Both policies interact and improve together, learning to generate and solve more and more scenarios.

Turning to FIG. 6, an example is shown in which an initial scene is sampled from a scenario where adversarial actors are designated at random. The teacher model operates to find rollouts from the scene where the student fails, but where the teacher model itself may pass to prevent the scenario from semantically changing (i.e., from deviating too far by the teacher controlled version from the student controlled version), the adversarial actions from the student rollout are replayed. A rollout is the playing of a scenario from an initial state to an end state, which may be to a collision or a predefined duration of time.

The adversarial actors (603) are selected in the initial state (601). The student actors (615) are selected for the initial student state (611) and are copied for the initial teacher state (661). The demonstrator actors (665) replace the student actors (615) for the initial teacher state (661). The student rollout (621) and the teacher rollout (671) are respectively performed with the initial student state (611) and the initial teacher state (661) to reach the end student state (631) and the end teacher state (681). For the end student state (631), one of the student actors (615) collides with one of the adversarial actors (603) unlike the end teacher state (681) in which there is no collision.

The scenario is part of a multi-agent traffic modeling formulation. The term sₜ=(sₜ¹, . . . , sₜ^{N}) is used to denote the joint state of N actors at time t, where each individual actor state sₜⁱ=(xₜⁱ, yₜⁱ, vₜⁱ, hₜⁱ) includes x, y position, velocity, and heading in birds eye view of the i-th actor. Actors' 2-D bounding box and class information may remain static over time and are also included in the state. Let c represent the initial states of the actors and high definition (HD) map capturing road and lane topology, each of which may remain fixed over time. Let aₜ=(aₜ¹, . . . , aₜ^{N}) denote the joint actions of the agents where aₜⁱ=(μₜⁱ, ϕₜⁱ) is defined as acceleration and steering angle. A scene rollout s_{≤T}, a_{≤T} can be obtained by sampling from,

$${p}_{θ} ( {s}_{\leq T} , {a}_{\leq T} \vert c ) = {\prod }_{t = 1}^{T} {π}_{θ} ( {a}_{t} \vert {s}_{\leq T} , c ) p ( {s}_{t} \vert {s}_{t - 1} , {a}_{t - 1} ) \qquad ( 1 )$$

where π_{θ} is a multi-agent policy controlling the actors jointly, and the transition dynamics p(sₜ|sₜ₋₁, aₜ₋₁)=Πᵢ₌₁^{N}p(sₜⁱ|sₜ₋₁ⁱ, aₜ₋₁ⁱ) are factorized per agent and modelled with the kinematic bicycle model.

To learn to automatically generate scenarios that are challenging, solvable, and realistic, an asymmetric self-play approach is implemented where a teacher policy aims to generate scenarios that a student policy would fail (i.e., collide), while still being able to demonstrate a valid (non-colliding) solution. To accomplish this, the teacher may control each of the actors in a scene or interact with a subset of student-controlled actors. The teacher is encouraged to induce collisions with student-controlled actors and avoid collisions with itself.

Let π_{T} and π_{S} be the multi-agent teacher and student policies, respectively. A scene may be controlled by the teacher by sampling actions from IT. However, it is also possible for the two policies to interact by controlling different actors within the same scene. If N actors are partitioned into two sets T and S, then the two policies π_{T} and π_{S} may be combined as π_{TS} to jointly control the scene,

$${π}_{T S} ( {a}_{t}^{i} \vert {s}_{\leq T} , c ) = \{ \begin{matrix}{π}_{T} ( {a}_{t}^{i} \vert {s}_{\leq T} , c ) if i ∈ T \\ {π}_{S} ( {a}_{t}^{i} \vert {s}_{\leq T} , c ) if i ∈ S\end{matrix} \qquad ( 2 )$$

$$and {π}_{T S} ( {a}_{t} \vert {s}_{\leq t} , c ) = {\prod }_{i = 1}^{N} {π}_{T S} ( {a}_{t}^{i} \vert {s}_{\leq t} , c ) .$$

The objective of the teacher is to generate scenarios that no actors under its control fail, but actors under the student's control fail, which is accomplished using Equation (3).

$${R}_{T} ( c ) = {\underbrace{- C ( {π}_{T} , N )}}_{Teacher collisions} + {\underbrace{C ( {π}_{TS} , S )}}_{Student collisions} + β {\underbrace{( {I}_{data} ( {π}_{T} ) + {I}_{data} ( {π}_{TS} ) )}}_{Realism} \qquad ( 3 )$$

$$where$$

$$C ( π , A ) = {𝔼}_{π \vert c} [ {\sum }_{i ∈ A} {c}_{i} ( {s}_{\leq T} ) ] \qquad ( 4 )$$

$${I}_{data} ( π ) = {𝔼}_{π \vert c} [ - log {p}_{data} ( {s}_{\leq T} \vert c ) ] . \qquad ( 5 )$$

Here cᵢ(s) is an indicator function that equals 1 if actor i fails (i.e., at-fault collision with another actor) and 0 otherwise. The first C(π_{T}, N) term rewards the teacher TIT for demonstrating a solvable scenario when controlling the N actors. The second C(π_{TS}, S) term rewards the teacher when actors controlled by the teacher induce collisions in actors controlled by the student. The I_{data}(π_{T}) and I_{data}(π_{TS}) terms provide realism regularization (when the teacher controls the actors and when the teacher interacts with the student respectively), where p_{data} is the data distribution and β is a hyperparameter controlling its strength. This objective encourages the teacher to generate behaviors that are challenging for student to handle, while still encouraging that at least the teacher can solve the scenario when the teacher is in control.

The student is rewarded when actors under its control do not fail when interacting with the teacher, along with the same realism regularization term.

$${R}_{S} ( c ) = - C ( {π}_{TS} , S ) + β {I}_{data} ( {π}_{TS} ) \qquad ( 6 )$$

The learning framework may include single-agent asymmetric self-play where the teacher searches for goal states that the student cannot reach. In the multiagent setting, the notion of a reachable state is instead replaced with the notion of a solvable scenario, which depends on interaction between the teacher and student.

While Equation (3) encourages teacher-solvable scenarios, the teacher has an unfair advantage as it can coordinate each of the actors and propose scenarios that have 0 reaction time to solve. The teacher may also try to identify student-controlled actors and act differently, proposing more difficult scenarios for the student.

To address unfair coordination, the teacher policy is divided into two sub-policies, adversary and demonstrator. When the teacher policy Ir is used to control the N actors of a scenario, the adversary sub-policy controls actors in T and the demonstrator sub-policy controls actors in S. Subdividing so that the demonstrator sub-policy that controls the student actors subjects the demonstrator to the same reaction time as the student (i.e., matches the architecture of ITS) to prevent the adversary sub-policy from proposing scenarios requiring 0 reaction time coordination (i.e., that are unsolvable by the student policy).

The teacher's reward in Equation (3) is a function of a pair of rollouts sampled from π_{T} and π_{TS} using identical initial conditions c. States may be replayed for actors in T in one simulation from the pair. Let ā_{≤T} be actions sampled from π_{TS}. Then when rolling out π_{T}, the modified policy is instead used

$${\hat{π}}_{T} ( {a}_{t}^{i} \vert {s}_{\leq t} , c ) = \{ \begin{matrix}δ ( {a}_{t}^{i} - {\overline{a}}_{t}^{i} ) & if i ∈ T \\ {π}_{T} ( {a}_{t}^{i} \vert {s}_{\leq t} , c ) & otherwise\end{matrix} \qquad ( 7 )$$

where δ is the dirac−δ function. Modifying the policies used according to Equation (4) prevents the teacher from treating itself differently, and forces the teacher to solve the same scenario subjected to the student. While the equation above is illustrative for when actors in π_{T} are replayed, during training, it may be randomly selected whether π_{T} or π_{TS} is replayed.

Turning to FIG. 7, the model (700) is part of an autonomous system model that processes inputs to generate outputs to control an autonomous system. The model (700) may be a neural network model that includes the map encoder (710), the state encoder (712), the transformer blocks (720), and the action decoder (750), which may each include multiple layers. The inputs include the lane graph data (702), the actor type data (705), and the actor state data (708).

The lane graph data (702) includes information about the lanes within which the autonomous system may operate. The lane graph data (702) is processed by the map encoder (710) to generate map features having the dimension [K, D]. The term K identifies the number of features and the term D identifies the number of dimensions for each feature.

The actor type data (705) includes information about the different actors and may identify which model (student, teacher, demonstrator, adversarial) is controlling the actor in the form of targeting embeddings. The actor state data includes information about the state of the actor in the context of the scene, which may include position, velocity, steering, braking, acceleration, etc., and may identify physical dimensions (e.g., length and width), categories types (of cars, trucks, pedestrians, etc.). The actor state data (708) is processed with the state encoder (712) to generate actor features having the dimensions [N, H, D]. The term N identifies the number of actors, the term H identifies the number time steps, and the term D identifies the number of dimensions for each feature. When used as a teacher model, the actor features output from the state encoder (712) may be combined (e.g., added to) the targeting embeddings of the actor type data (705) so that the teacher model may distinguish between the different types of actors in a scenario.

The outputs of the map encoder (710) and the state encoder (712) are input to the transformer blocks (720). The transformer blocks (720) is a set of multiple transformer blocks in which each transformer block includes a map cross attention block (722), an actor self attention block (725), and a time self attention block (728). The map cross attention block (722) performs cross attention between the output of the map encoder and the output of the state encoder. The actor self attention block (725) performs self attention along the actor axis N. The time self attention block (728) performs self attention along the time axis H. The actor self attention block (725) may operate on the output from the map cross attention block (722). The time self attention block (728) may operate on the output from the actor self attention block (725).

The output of the transformer blocks (720) are input to the action decoder (750) to generate the actor actions (770). The actor actions (770) have the dimensions of [N, 2] in this example to indicate that two actions (braking and steering) are identified for each actor in the scenario.

For the neural network architecture, the policy network is implemented with a viewpoint invariant transformer architecture. Given the lane graph g of the local map with K nodes, a viewpoint agnostic map encoder (710) is used to extract a set of lane graph node features {mₖ}ₖ₌₁^{K},

$${\{ {m}_{k} \}}_{k = 1}^{K} = MapEncoder ( g ) \qquad ( 8 )$$

Then, for each actor i, the state encoder (712) uses a multi-layer perceptron (MLP) to extract a set of features for each of its past state s_{t-H}ⁱ, . . . , sₜⁱ over the history horizon H≥1,

$${h}_{t}^{i} , = StateEncoder ( {φ}_{t \to {t}^{′}}^{i} ⊕ [ {v}_{t}^{i} , {ℓ}^{i} , {w}^{i} ] ) , {t}^{′} = t - H + 1 , … . t \qquad ( 9 )$$

where ⊕ is the concatenation operator, v, [symbol] , w are velocity, length, and width of the actor, and ϕ_{t→t}ⁱ is the PairPose relative positional features (which may include features between pairs of the positions of the actors) between the i-th actor's state at the current timestep t and at a past timestep t′; i.e., g_{i→j}^{a}. Each actor feature hₜⁱ encodes the I-th actor's state at t′ in its local coordinate frame at t, therefore preserving viewpoint-invariance.

Next, a stack (the transformer blocks (720)) of interleaving actor-to-time transformer layers (the time self attention block (728)), actor-to-actor transformer layers (the actor self attention block (725)), and actor-to-map transformer layers (the map cross attention block (722)) is used to capture interactions between the actor and lane graph features. The actor-to-time transformer layer uses an attention mechanism, with sinusoidal positional encoding to break the symmetry across time. To model actor-to-actor interactions in a viewpoint-invariant manner, the attention mechanism is extended to use relative positional encodings between actors. For the i-th actor at timestep t′, attention is computed with key kᵢ, queries {q_{i,j}}ⱼ₌₁^{N}, and values {v_{i,j}}ⱼ₌₁^{N},

$${k}_{{t}^{′}}^{i} = {h}_{{t}^{′}}^{i} , {q}_{i , j} = {v}_{i , j} + MLP ( φ {t}^{′} , i \to j ) \qquad ( 10 )$$

where φt′, i→j is the PairPose features between actors i and j at timestep t′.

The same or similar attention mechanism is used in the actor-to-map transformer layer, which may include two modifications. In one modification, the actor-to-map attention may be conducted for the actor features at the current timestep t. In another modification, the queries and values used may be that of the actor's k nearest lane graph nodes, which may be based on Euclidean distance.

The action decoder (750) uses a multilayer perceptron (MLP) to deterministically output each actor's steering and acceleration by decoding the features at the current timestep t after M blocks of transformer layers.

$${a}_{t}^{i} = ActionDecoder ( {h}_{t}^{i} ) \qquad ( 11 )$$

The policy can then be unrolled in the environment in a sliding window fashion.

The use of Equations (3) and (6) may be enhanced in practice. During training, agents may be randomly assigned into T. The discrete indicator function cᵢ(s) may be relaxed to a differentiable collision loss. A specific target actor may be assigned for each actor in T for which the collision loss is active. An additional distance loss for each adversarial actor towards its target may be applied. To encode the information that actor i is targeting actor j

$${h}_{t}^{i} ← {h}_{t}^{i} + MLP ( e ⊕ φ t , i \to j ) \qquad ( 12 )$$

where e is a learnable embedding (referred to as a targeting embedding) to indicate the actor is in T, and the PairPose features provides positional information on the target. In a 3-player formulation (student, adversarial teacher, and demonstrator teacher), the adversarial sub-policy has access to the information from e. As the relaxed reward is differentiable, backpropagation through time may be used to directly optimize the learning objective.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8.1, the computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing units (TPU), combinations thereof, etc.

The input devices (810) may include a touchscreen, keyboard, mouse, microphone, touchpad, electronic pen, or any other type of input device. The input devices (810) may receive inputs from a user that are responsive to data and messages presented by the output devices (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output devices (808) may include a display device, a printer, external storage, or any other output device. One or more of the output devices may be the same or different from the input device(s). The input and output device(s) may be locally or remotely connected to the computer processor(s) (802). Many different types of computing systems exist, and the aforementioned input and output device(s) may take other forms. The output devices (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8.1 may be connected to or be a part of a network. For example, as shown in FIG. 8.2, the network (820) may include multiple nodes (e.g., node X (822), node Y (824)). Each node may correspond to a computing system, such as the computing system shown in FIG. 8.1, or a group of nodes combined may correspond to the computing system shown in FIG. 8.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8.1. Further, the client device (826) may include and/or perform all or a portion of one or more embodiments.

The computing system of FIG. 8.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
executing a scenario comprising a set of actors;
determining a student action in the scenario using a student model for a student actor of the set of actors;
determining a teacher action in the scenario using a teacher model for a teacher actor of the set of actors;
processing a student reward function based on the student action to reduce a student collision likelihood of the student model;
processing a teacher reward function based on the teacher action to reduce a teacher collision likelihood of the teacher model and increase the student collision likelihood of the student model;
iteratively updating the student model and the teacher model using the student reward function and the teacher reward function; and
saving the student model as a virtual driver of an autonomous system.

2. The method of claim 1, further comprising:
deploying the student model to the autonomous system; and
executing the student model to operate the autonomous system to avoid a collision.

3. The method of claim 1, wherein executing the scenario comprises
executing an autonomous system model using a student policy as the student model; and
executing the autonomous system model using a teacher policy as the teacher model.

4. The method of claim 1, wherein processing the student reward function comprises:
processing the student reward function with a regularization hyperparameter controlling a combined regularization term.

5. The method of claim 1, wherein processing the teacher reward function comprises:
processing the teacher reward function with a regularization hyperparameter controlling a teacher regularization term and a combined regularization term.

6. The method of claim 1, wherein determining the teacher action comprises:
determining the teacher action in the scenario from one of an adversary sub-policy and a demonstrator sub-policy.

7. The method of claim 1, wherein determining one or more of the student action and the teacher action comprises:
processing a lane graph with a map encoder to generate lane graph node features;
and processing actor data with a state encoder to generate actor features for one or more of the teacher model and the student model.

8. The method of claim 1, wherein determining one or more of the student action and the teacher action comprises:
processing lane graph node features and actor features using a set of transformer blocks to generate transformer block output features for one or more of the teacher model and the student model,
wherein each of the transformer blocks comprises a map cross attention block, an actor self attention block, and a time self attention block.

9. The method of claim 1, wherein determining one or more of the student action and the teacher action comprises:
processing transformer block output features with an action decoder to generate a set of actor actions for one or more of the teacher model and the student model.

10. The method of claim 1, wherein determining the teacher action comprises:
revising actor features with a targeting embedding to distinguish between the student actor controlled by the student model and the teacher actor controlled by the teacher model.

11. A system comprising:
at least one processor; and
an application that, when executing on the at least one processor, performs stored operations comprising:
executing a scenario comprising a set of actors,
determining a student action in the scenario using a student model for a student actor of the set of actors,
determining a teacher action in the scenario using a teacher model for a teacher actor of the set of actors,
processing a student reward function based on the student action to reduce a student collision likelihood of the student model,
processing a teacher reward function based on the teacher action to reduce a teacher collision likelihood of the teacher model and increase the student collision likelihood of the student model,
iteratively updating the student model and the teacher model using the student reward function and the teacher reward function, and
saving the student model as a virtual driver of an autonomous system.

12. The system of claim 11, wherein the application further performs:
deploying the student model to the autonomous system; and
executing the student model to operate the autonomous system to avoid a collision.

13. The system of claim 11, wherein executing the scenario comprises
executing an autonomous system model using a student policy as the student model; and
executing the autonomous system model using a teacher policy as the teacher model.

14. The system of claim 11, wherein processing the student reward function comprises:
processing the student reward function with a regularization hyperparameter controlling a combined regularization term.

15. The system of claim 11, wherein processing the teacher reward function comprises:
processing the teacher reward function with a regularization hyperparameter controlling a teacher regularization term and a combined regularization term.

16. The system of claim 11, wherein determining the teacher action comprises:
determining the teacher action in the scenario from one of an adversary sub-policy and a demonstrator sub-policy.

17. The system of claim 11, wherein determining one or more of the student action and the teacher action comprises:
processing a lane graph with a map encoder to generate lane graph node features;
and processing actor data with a state encoder to generate actor features for one or more of the teacher model and the student model.

18. The system of claim 11, wherein determining one or more of the student action and the teacher action comprises:
processing lane graph node features and actor features using a set of transformer blocks to generate transformer block output features for one or more of the teacher model and the student model,
wherein each of the transformer blocks comprises a map cross attention block, an actor self attention block, and a time self attention block.

19. The system of claim 11, wherein determining one or more of the student action and the teacher action comprises:
processing transformer block output features with an action decoder to generate a set of actor actions for one or more of the teacher model and the student model.

20. A non-transitory computer readable medium comprising stored instructions executable by at least one processor to perform:
executing a scenario comprising a set of actors;
determining a student action in the scenario using a student model for a student actor of the set of actors;
determining a teacher action in the scenario using a teacher model for a teacher actor of the set of actors;
processing a student reward function based on the student action to reduce a student collision likelihood of the student model;
processing a teacher reward function based on the teacher action to reduce a teacher collision likelihood of the teacher model and increase the student collision likelihood of the student model;
iteratively updating the student model and the teacher model using the student reward function and the teacher reward function; and
saving the student model as a virtual driver of an autonomous system.
